(19) United States
(12) Patent Application Publication
(10) Pub. No.: US 2014/0285301 A1
(43) Pub. Date: Sep. 25, 2014

(54) SURFACE MOUNT INDUCTOR AND METHOD OF MANUFACTURING THE SAME

(71) Applicant: TOKO, INC., Tsurugashima-shi (JP)

(72) Inventors: Takumi ARAI, Tsurugashima-shi (JP); Takeo OHAGA, Tsurugashima-shi (JP); Yasutaka MIZUKOSHI, Tsurugashima-shi (JP); Masaaki TOTSUKA, Tsurugashima-shi (JP); Kunio SASAMORI, Tsurugashima-shi (JP)

(73) Assignee: TOKO, INC., Tsurugashima-shi (JP)

(21) Appl. No.: 14/217,752

(22) Filed: Mar. 18, 2014

(30) Foreign Application Priority Data
Mar. 22, 2013 (JP) 2013-059492

(51) Int. Cl. H01F 5/04; H01F 41/10

(52) U.S. Cl. CPC H01F 5/04; H01F 41/10
USPC 336/192; 29/605

(57) ABSTRACT

A surface mount inductor including a drum core having a pair of flanges at both ends of a winding shaft thereof, a winding formed by winding an insulation-coated wire around the winding shaft, and a pair of plate-like metal terminals arranged on a flange surface of the drum core and each having a protrusion part protruding from a perimeter of the flange, wherein terminals of the winding are tied around the protrusion parts, the protrusion parts are compressed in a vertical direction and formed to have a predetermined height-direction dimension, and tied parts are immersed in a solder bath to be subjected to connection processing.

### CROSS-REFERENCE TO RELATED APPLICATIONS

This application is based upon and claims the benefit of priority from the prior Japanese Patent Application No. 2013-059492, filed on Mar. 22, 2013, the entire contents of which are incorporated herein by reference.

### BACKGROUND OF THE INVENTION

1. Field of the Invention

The present invention relates to a surface mount inductor using a magnetic drum core.

2. Description of the Related Art

Inductors using drum cores are used for choke coils of DC/DC converters or the like. In general, a surface mount inductor which is obtained by forming such an inductor into a shape that allows for surface mounting is used.

FIG. 3A and FIG. 3B are diagrams for illustrating a conventional surface mount inductor, where FIG. 3A is a vertical sectional view, and FIG. 3B is a schematic perspective view for illustrating in detail a tied part A₀ shown in a dotted line in FIG. 3A.

As shown in FIG. 3A and FIG. 3B, the conventional surface mount inductor 19 includes a drum core 12 having a winding shaft 12c that has an upper flange 12a and a lower flange 12b provided at the ends thereof, a winding 14 wound around the winding shaft 12c, and a pair of metal terminals 15 and 15 arranged on the bottom surface of the lower flange 12b.

Each metal terminal 15 has a mounting part 15b and a protrusion part 15a that is formed by cranking from the mounting part 15b, where the mounting part 15b is adhered and fixed to the bottom surface of the lower flange 12b of a drum core 12, and a winding terminal 14a is tied around the protrusion part 15a.

The protrusion part 15a (tied part A₀) with the winding terminal 14a tied therearound is immersed in a solder bath to be soldered, to be electrically connected to the winding 14. The drum core 12 is contained in an interior hole of a ring core 13 such that the tied part A₀ is arranged in a notch 13a provided in the ring core 13.

### BRIEF SUMMARY OF THE INVENTION

### Problem to be Solved by the Invention

To enhance conversion efficiency of a DC/DC converter, a direct current resistance R_{DC} needs to be reduced, and a choke coil used in the DC/DC converter is therefore preferably made of a wire as thick as possible.

However, a thick wire is hard to bend, which makes tying around the protrusion part difficult, and the tied part A₀ therefore considerably swells, which makes a height-direction dimension h₀ of the tied part A₀ larger. Thus, there is a problem with the conventional surface mount inductor 19 in that the tied part A₀ is taller than the mounting part 15b, or the notch 13a in the ring core provided for sheltering the tied part A₀ needs to be largely cut out.

In addition, there is a problem that since the tied part A₀ has many gaps in the winding, solder is excessively accumulated between the gaps at the time of immersion in the solder bath, which makes the solder prone to have horn shapes, or so-called undesirable solder projections.

### Means for Solving the Problem

To solve the above problems, a surface mount inductor of the present invention includes:

a drum core having a pair of flanges at both ends of a winding shaft thereof; a winding formed by winding an insulation-coated wire around the winding shaft; and a pair of plate-like metal terminals arranged on a flange surface of the drum core and each having a protrusion part protruding from a perimeter of the flange, wherein

terminals of the winding are tied around the protrusion parts, and

windings of the protrusion parts are compressed in a vertical direction and formed to have a predetermined height-direction dimension, and are immersed in a solder bath to be subjected to connection processing.

In addition, a method of manufacturing a surface mount inductor of the present invention including a drum core having a pair of flanges at both ends of a winding shaft thereof, a winding formed by winding an insulation-coated wire around the winding shaft, and a pair of plate-like metal terminals arranged on a flange surface of the drum core and each having a protrusion part protruding from a perimeter of the flange, the method includes:

adhering the pair of metal terminals on the flange surface;

winding the wire around the drum core;

tying terminals of the winding around the protrusion parts;

compressing windings of the protrusion parts in a vertical direction of the metal terminal such that the windings of the protrusion parts are formed to have a predetermined height-direction dimension; and

immersing the protrusion part in a solder bath to perform electrical connection processing.

### Effect of the Invention

According to the surface mount inductor of the present invention, since the tied part is compressed and formed so as to have a predetermined height-direction dimension, swelling of the tied part can be made small. As a result, a surface mount inductor can be made in which the tied part is not taller than a mounting part, a notch in a ring core is small, and undesirable solder projections are hard to be generated.

In addition, according to a method of manufacturing a surface mount inductor of the present invention, since the protrusion part is immersed in a solder bath after the tied part is compressed and formed so as to have a predetermined height-direction dimension, swelling of the tied part can be made small. As a result, a surface mount inductor can be manufactured in which the tied part is not taller than a mounting part, a notch in the ring core is small, and the undesirable solder projections are hard to be generated.

### BRIEF DESCRIPTION OF THE DRAWINGS

FIG. 1A is a vertical sectional view illustrating one embodiment of the present invention;

FIG. 1B is a perspective view showing a tied part of the one embodiment of the present invention;

FIG. 2A to FIG. 2F are assembly process charts illustrating a method of manufacturing the one embodiment of the present invention;

FIG. 3A is a vertical sectional view illustrating a conventional surface mount inductor; and

FIG. 3B is a perspective view showing a tied part of the conventional surface mount inductor.

### DETAILED DESCRIPTION OF THE INVENTION

Hereafter, a configuration of a surface mount inductor of the present invention will be described together with a method of manufacturing the same with reference to the drawings.

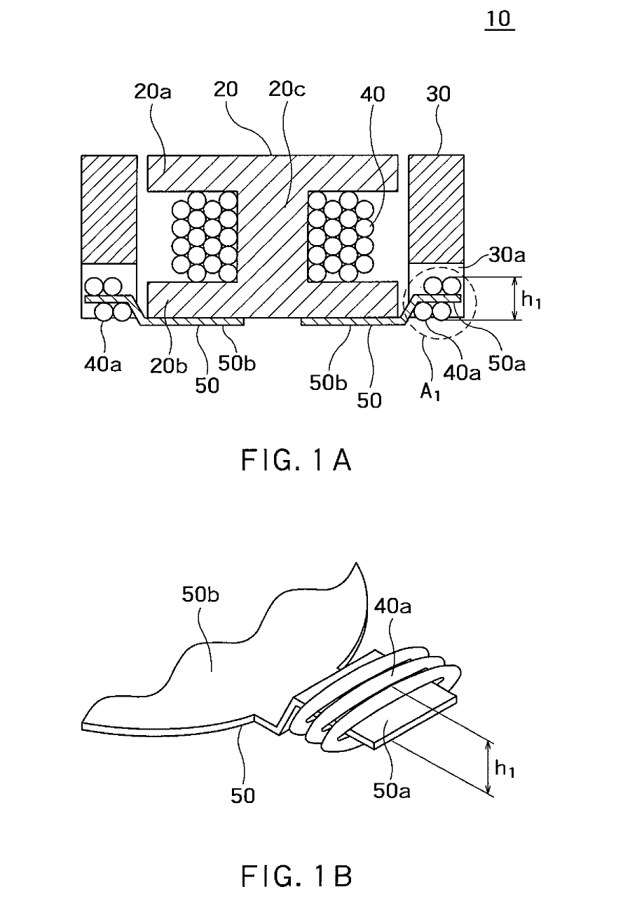

FIG. 1A and FIG. 1B are drawings illustrating the surface mount inductor of the present invention, where FIG. 1A shows a schematic sectional view, and FIG. 1B shows a schematic perspective view for illustrating in detail a tied part A₁ shown in a dotted line in FIG. 1A.

As shown in FIG. 1A and FIG. 1B, a surface mount inductor 10 of the present invention includes a drum core 20 that has an upper flange 20a and a lower flange 20b provided at the ends of a winding shaft 20c, a winding 40 wound around the winding shaft 20c, and a pair of metal terminals 50 and 50 arranged on the bottom surface of the lower flange 20b.

The drum core 20 is made of a magnetic material such as a nickel ferrite, which has a high resistance. Therefore, the metal terminals 50 and 50 will not be short-circuited to each other even when the metal terminals 50 are directly adhered on the flange surface of the drum core 20.

The winding 40 to be used is a wire that has a circular cross section and is subjected to insulation coating with a polyurethane resin or the like.

The metal terminal 50 is formed by punching a metal plate made of a phosphor bronze or the like having a surface subjected to plate processing, into a predetermined shape, and folding the metal plate by a press or the like. In addition, the metal terminal 50 has a semicircle-shaped mounting part 50b, and a protrusion part 50a that has a relatively small width and is provided linearly protruding in a direction toward a perimeter from the mounting part 50b and being folded in a cranked manner. In the metal terminal 50, the mounting part 50b is adhered on the bottom surface of the lower flange 20b of the drum core 20, and a winding terminal 40a is tied around the protrusion part 50a.

The protrusion part 50a (tied part A₁) with the winding terminal 40a tied therearound is compressed in a vertical direction of the metal terminal 50 to make a height-direction dimension thereof small, such that a height-direction dimension of the metal terminal 50 measures a predetermined value h₁. Next, the tied part A₁ is immersed into a solder bath.

Finally, the drum core 20 is contained in an interior hole of the ring core 30 and is fixed with an adhesive such that the tied part A₁ is arranged in the notch 30a provided in the ring core 30.

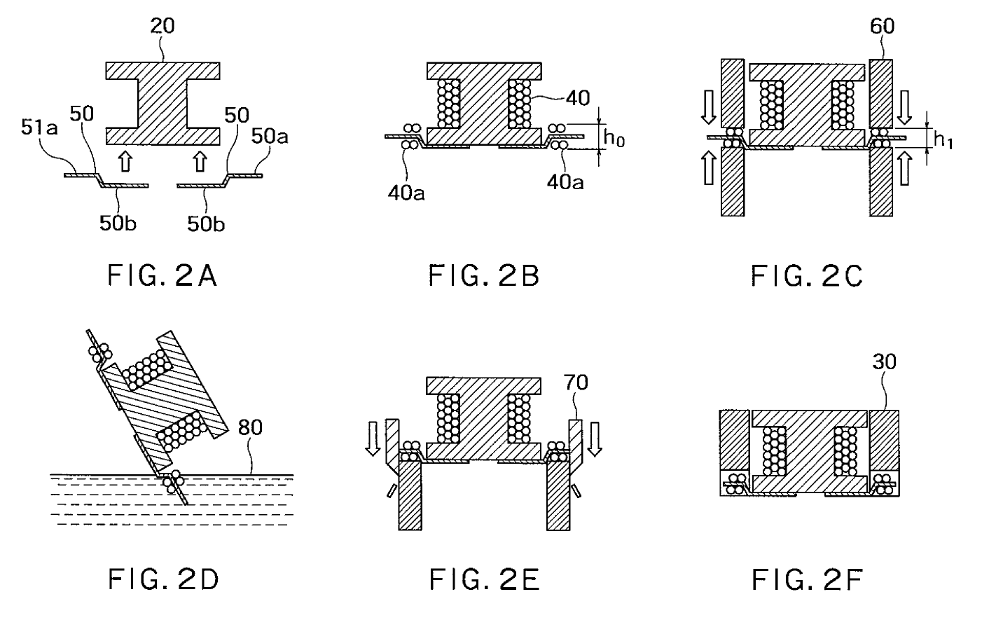

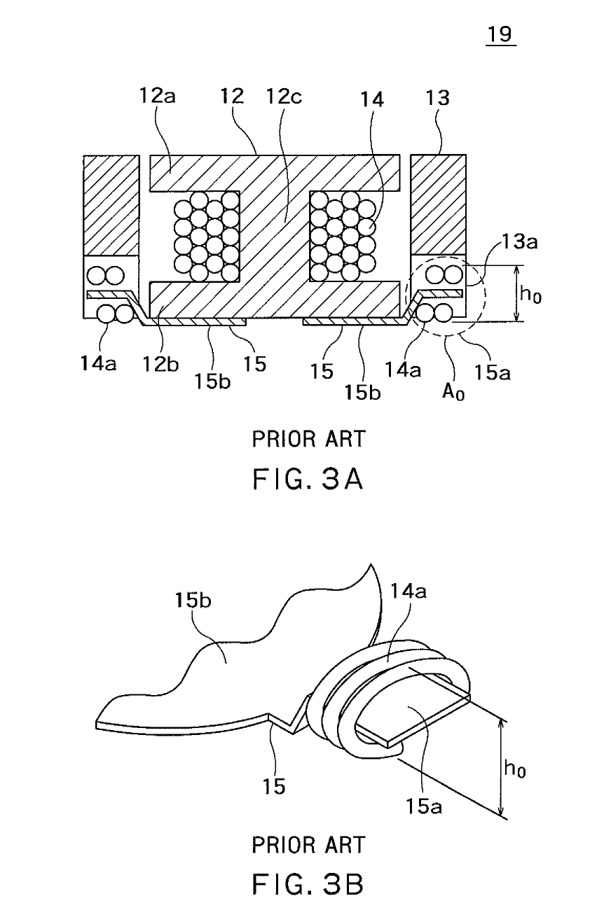

FIG. 2A to FIG. 2F are assembly process charts for illustrating a method of manufacturing the surface mount inductor of the present invention.

First, as shown in FIG. 2A, the pair of metal terminals 50 and 50 including the protrusion parts 50a provided therein are fixed on the bottom surface of the lower flange 20b of the drum core 20 with an adhesive.

Next, as shown in FIG. 2B, the winding 40 is wound around the winding shaft 20c by, for example, rotating the drum core 20 with the upper flange 20a held. Then, the winding terminals 40a and 40a are tied around the protrusion parts 50a and 50a of the metal terminals 50 and 50, respectively.

In this process, if the wire of the winding 40 is hard to bend because the diameter thereof is large, gaps are made between the winding terminal 40a and the protrusion part 50a, as shown in FIG. 2B, and as a result, the height-direction dimension h₀ of the tied part A₁ is large.

Hereupon, as shown in FIG. 2C, the tied part A₁ is compressed in the vertical direction of the metal terminal 50 using a jig 60 so as to have a predetermined dimension h₁. The predetermined dimension means such a dimension that a gap between the metal terminal 50 and the winding 40 is small and the winding 40 approaches a metal plate surface of the metal terminal 50 so as to narrow the gap between the metal terminal 50 and the winding terminal 40a, but the cross section of the wire is not deformed.

Since the winding terminal 40a is coated, if it is shorter than the predetermined dimension h₁, the wire of the winding terminal 40a is not crimped but the cross section thereof is only deformed. That is, the predetermined dimension h₁ is preferably larger than the sum of twice the diameter of the wire and the thickness of the metal terminal 50.

Then, as shown in FIG. 2D, the tied part A₁ is immersed in the solder bath 80 so as to remove the coating on the winding terminal and to electrically connect the winding terminal 40a with the metal terminal 50.

Then, as shown in FIG. 2E, unnecessary protrusion parts and winding ends are shorn and removed by a blade 70.

Finally, as shown in FIG. 2F, the drum core 20 is contained in the interior hole of the ring core 30 and fixed with an adhesive such that the tied part A₁ is arranged in the notch 30a provided in the ring core 30, as shown in FIG. 1A.

In the abovementioned surface mount inductor 10, since the height-direction dimension of the tied part A₁ is small, there is no possibility that the lower surface of the tied part A₁ is higher than the mounting part 50b. Furthermore, the notch 30a in the ring core for sheltering the tied part A₁ can be made small.

Still further, since the tied part A₁ has few gaps, the amount of solder attached at the time of immersion in the solder bath can be kept to a minimum. Therefore, a surface mount inductor can be manufactured in which generation of the undesirable solder projections is inhibited.

Note that since a distance between the winding terminal 40a and the metal terminal 50 is short, the effect of reducing a direct current resistance R_{DC} can be expected.

Although there is described above the embodiment of the surface mount inductor in which the drum core and the ring core are combined, the present invention can be also applied to a surface mount inductor without a ring core. Furthermore, the present invention can be also applied to a surface mount inductor in which a resin containing a magnetic powder mixed therein is filled between flanges of a drum core.

### Explanation of Codes

10, 19 surface mount inductor

12, 20 drum core

12a, 20a upper flange

12b, 20b lower flange

12c, 20c winding shaft

13, 30 ring core

14, 40 winding

14a, 40a winding terminal

15, 50 metal terminal

15a, 50a protrusion part

15b, 50b mounting part

60 jig

70 blade

80 solder bath

1. A surface mount inductor comprising a drum core having a pair of flanges at both ends of a winding shaft thereof, a winding formed by winding an insulation-coated wire around the winding shaft, and a pair of plate-like metal terminals arranged on a flange surface of the drum core and each having a protrusion part protruding from a perimeter of the flange, wherein
terminals of the winding are tied around the protrusion parts, and
windings of the protrusion parts are compressed in a vertical direction and formed to have a predetermined height-direction dimension, and are immersed in a solder bath to be subjected to connection processing.

2. The surface mount inductor according to claim 1, further comprising a ring-shaped core arranged around a perimeter of the drum core.

3. A method of manufacturing a surface mount inductor comprising a drum core having a pair of flanges at both ends of a winding shaft thereof, a winding formed by winding an insulation-coated wire around the winding shaft, and a pair of plate-like metal terminals arranged on a flange surface of the drum core and each having a protrusion part protruding from a perimeter of the flange, the method comprising:
adhering the pair of metal terminals on the flange surface;
winding the wire around the drum core;
tying terminals of the winding around the protrusion parts;
compressing windings of the protrusion parts in a vertical direction of the metal terminal such that the windings of the protrusion parts are formed to have a predetermined height-direction dimension; and
immersing the protrusion part in a solder bath to perform connection processing.

4. The method of manufacturing the surface mount inductor according to claim 3, further comprising arranging a ring-shaped core around a perimeter of the drum core.
